(19) United States
(12) Patent Application Publication
(10) Pub. No.: US 2019/0320102 A1
(43) Pub. Date: Oct. 17, 2019

(54) POWER REDUCTION FOR DUAL CAMERA SYNCHRONIZATION

(71) Applicant: QUALCOMM Incorporated, San Diego, CA (US)

(72) Inventors: Tanvi Aggarwal, Hyderabad (IN); Vijay Kumar Tumati, Hyderabad (IN); Ajay Kumar Dhiman, Hyderabad (IN)

(21) Appl. No.: 15/952,936

(22) Filed: Apr. 13, 2018

(51) Int. Cl. H04N 5/225; H04N 5/232; H04N 5/262

(52) U.S. Cl. CPC H04N 5/2258; H04N 5/2621; H04N 5/23241

(57) ABSTRACT

Methods and apparatuses are disclosed for reducing power consumption in image processing systems comprising a master image sensor and a slave image sensor synchronized to the master image sensor. For example, a synchronization signal may be periodically sent from the master image sensor to the slave image sensor, where the synchronization signal is sent once per synchronization period and indicates a frame start time. A time may be estimated to complete an image processing operation. A comparison may be made between the estimated time and the synchronization period, and a frame capture rate of the slave image sensor may be selectively adjusted based at least in part on the comparison.

### TECHNICAL FIELD

The present aspects relate generally to image processing in mobile devices.

### BACKGROUND

Many devices (such as smartphones, tablets, digital cameras, and so on) include two or more cameras, and have begun to support image processing operations incorporating two or more cameras. Some operations may simulate effects of conventional lensed cameras and may be used, for example, for capturing a portrait of a subject. For example, devices may support “real-time bokeh” operations, where foreground objects are in focus and background objects are out of focus. Operations for image capture and processing using multiple cameras may be relatively more complex than conventional image capture and processing operations for a single camera. For example, conventional devices require synchronization of multiple cameras.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure are directed to methods and apparatuses for reducing power consumption in image processing systems comprising a master image sensor and a slave image sensor synchronized to the master image sensor. In one aspect, an example method is disclosed. The method may include periodically sending a synchronization signal from a master image sensor of a multiple camera module to a slave image sensor of the multiple camera module, where the synchronization signal is sent once per synchronization period and indicates a frame start time. A time required to complete an image processing operation may be estimated. The estimated time may be compared to the synchronization period, and a frame update rate of the slave image sensor may be selectively adjusted based at least in part on the comparison.

In another aspect, an image processing device is disclosed. The image processing device may include two or more image sensors, including a master image sensor and a slave image sensor synchronized to the master image sensor. The image processing device may further include one or more processors, and a memory coupled to the two or more image sensors and to the one or more processors. The memory may store instructions that, when executed by the one or more processors, cause the image processing device to periodically send a synchronization signal from the master image sensor to the slave image sensor, the synchronization signal sent once per synchronization period and indicating a frame start time, estimate a time required to complete an image processing operation, compare the estimated time to the synchronization period, and selectively adjust a frame update rate of the slave image sensor based at least in part on the comparing.

In another aspect, a non-transitory computer-readable storage medium is disclosed. The non-transitory computer-readable storage medium stores instructions that, when executed by one or more processors of an image processing device, cause the image processing device to periodically send a synchronization signal from the master image sensor to the slave image sensor, the synchronization signal sent once per synchronization period and indicating a frame start time, estimate a time required to complete an image processing operation, compare the estimated time to the synchronization period, and selectively adjust a frame update rate of the slave image sensor based at least in part on the comparing.

In another aspect, an image processing device is disclosed. The image processing device may include means for periodically sending a synchronization signal from a master image sensor to a slave image sensor synchronized to the master image sensor, the synchronization signal sent once per synchronization period, and indicating a frame start time, means for estimating a time required to compete an image processing operation, means for comparing the estimated time to the synchronization period, and means for selectively adjusting a frame update rate of the slave image sensor based at least in part on the comparing.

### BRIEF DESCRIPTION OF THE DRAWINGS

The disclosure herein is illustrated by way of example, and not by way of limitation, in the figures of the accompanying drawings and in which like reference numerals refer to similar elements.

FIG. 1A shows an example device including a dual camera on the front of the device.

FIG. 1B shows another example device including a dual camera on the front of the device.

FIG. 1C shows an example device including a dual camera on the back of the device.

FIG. 1D shows another example device including a dual camera on the back of the device.

FIG. 2 is a block diagram of an example image processing device.

FIG. 3 shows a plot of a clock synchronization for a master image sensor and a slave image sensor.

FIG. 4 shows a plot of an example reduced-power clock synchronization for a master image sensor and a slave image sensor.

FIG. 5 shows a plot of another example reduced power clock synchronization for a master image sensor and a slave image sensor.

FIG. 6 is an illustrative flow chart depicting an example reduced-power synchronization operation.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the example implementations. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Many electronic devices include a camera for imaging. Example devices include, but are not limited to, wireless communications devices (such as a cell phone, smartphone, tablet, digital camera, laptop computer, personal digital assistant (PDA), and so on), vehicles, security systems, and so on. Some of those devices include a multiple camera solution for imaging. A multiple camera solution may include multiple cameras (including multiple image sensors, multiple apertures, and/or multiple lenses). An example multiple camera solution is a dual camera with a primary camera and an auxiliary camera. Additionally, a device to incorporate multiple cameras (such as a dual camera) may include multiple image signal processors (ISPs), where captures from one camera are processed by one ISP and captures from another camera are processed by a different ISP.

Devices with multiple cameras have multiple image sensors. For example, a device's dual camera may include a master image sensor (such as for a primary camera) and a slave image sensor (such as for an auxiliary camera). In synchronizing the cameras, the slave image sensor may be synchronized to the master image sensor. For example, conventional devices may synchronize the slave image sensor capture rate to the master image sensor capture rate. A number of image capture and processing operations may require such synchronization of the master image sensor and the slave image sensor—such synchronization may result in the slave image sensor capturing images at the same times and at the same frame rate as the master image sensor. For example, synchronization may be important for real-time bokeh operations, advanced optical zoom operations employing both a wide and a tele lens, three-dimensional rendering applications where a depth sensor may be required to work in synchronization with a main image sensor, features such as synchronized front camera and rear camera recording, 360-degree camera operations, and so on.

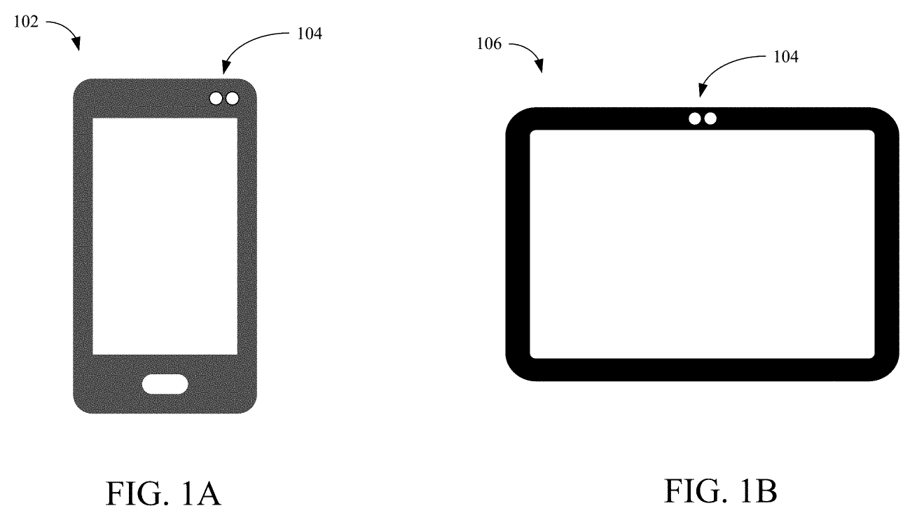

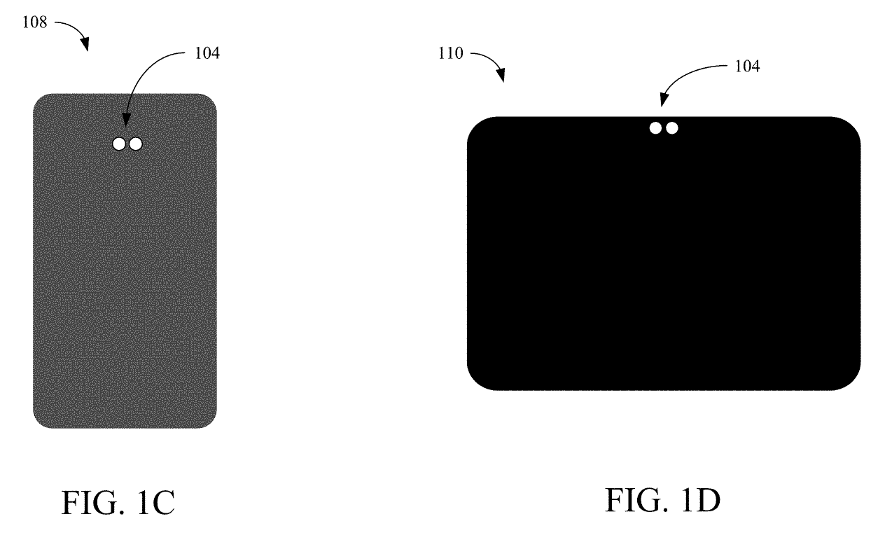

FIGS. 1A-D show some example devices with a dual camera. FIG. 1A shows an example smartphone 102 including a dual camera 104 on the front of the smartphone 102. FIG. 1B shows an example tablet 106 including a dual camera 104 on the front of the tablet 106. FIG. 1C shows an example smartphone 108, such as smartphone 102 in FIG. 1A, including a dual camera 104 on the back of the smartphone 108. FIG. 1D shows an example tablet 110, such as tablet 106 in FIG. 1B, including a dual camera 104 on the back of the tablet 110.

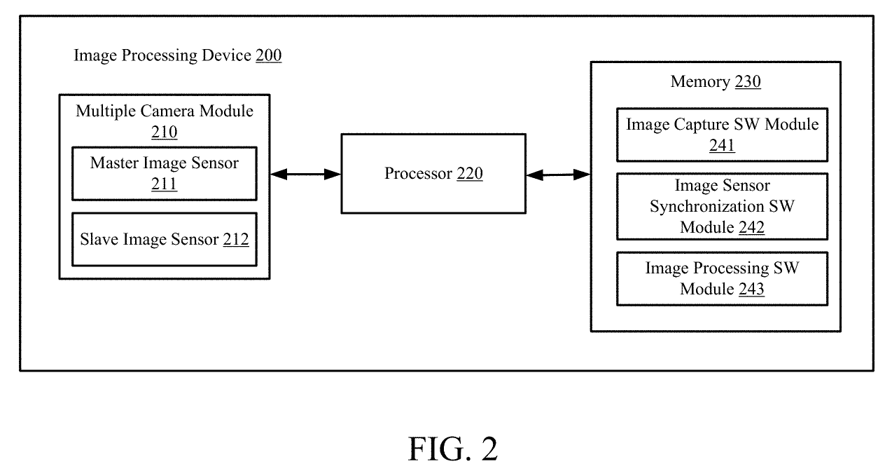

FIG. 2 is a block diagram of an example image processing device 200. The image processing device 200 may be an example implementation of devices 102, 106, 108, and 110 in FIGS. 1A-D. The image processing device 200 may include a multiple camera module 210, a processor 220, and a memory 230. The multiple camera module 210 may include at least a master image sensor 211 and a slave image sensor 212. In some example implementations, the slave image sensor 212 is synchronized to the master image sensor 211. While the multiple camera module 210 is shown to include the master image sensor 211 and the slave image sensor 212, the multiple camera module 210 may include any number of cameras or image sensors.

In some example implementations, the master image sensor 211 and the slave image sensor 212 may include one or more color filter arrays (CFAs) arranged on a surface of the respective sensor, and may be coupled directly or indirectly to processor 220. The multiple camera module 210 may alternatively include other types of image sensors for capturing images. For example, the master image sensor 211 and/or the slave image sensor 212 may include arrays of solid state sensor elements such as complementary metal-oxide semiconductor (CMOS) sensor elements, or other appropriate image sensor components.

The multiple camera module 210 and the memory 230 may be coupled to the processor 220. While shown to be coupled to each other via the processor 220, the processor 220, the memory 230, the multiple camera module 210 may be coupled to one another in various arrangements. For example, the processor 220, the memory 230, and/or multiple camera module 210 may be coupled to each other via one or more local buses (not shown for simplicity). While not shown in FIG. 2 for simplicity, the image processing device 200 may further include or be coupled to one or more displays, to one or more networks, to one or more image processing cores, such as a video encoding core, one or more image compression cores, a power source (such as a battery), and so on.

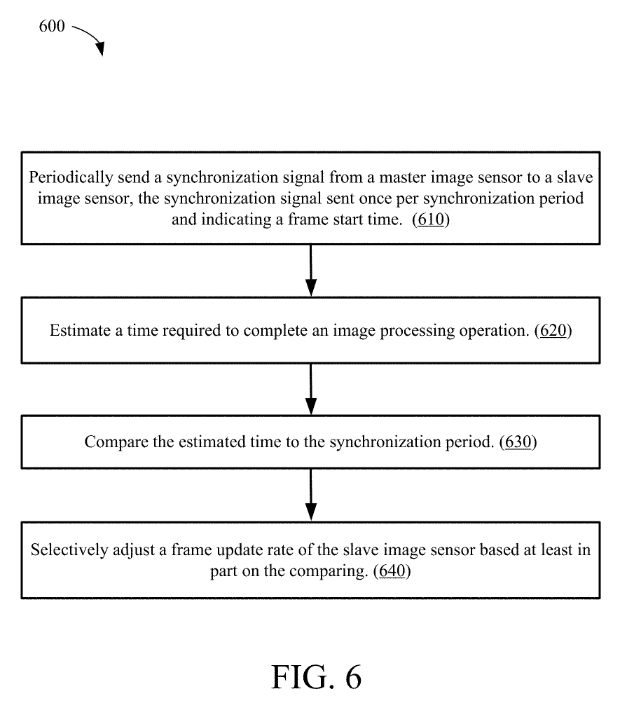

Memory 230 may include a non-transitory computer-readable medium (e.g., one or more nonvolatile memory elements, such as EPROM, EEPROM, Flash memory, a hard drive, and so on) that may store at least the following software (SW) modules:
an image capture SW module 241 to capture and receive images using the multiple camera module 210;
an image sensor synchronization SW module 242 to generate and send synchronization signals for synchronizing the slave image sensor 212 to the master image sensor 211; and
an image processing SW module 243 to perform image processing operations on captured images.
   Each software module includes instructions that, when executed by processor 220, cause the image processing device 200 to perform the corresponding functions. The non-transitory computer-readable medium of memory 230 thus includes instructions for performing all or a portion of the operations depicted in FIG. 6.

Processor 220 may be any suitable one or more processors capable of executing scripts or instructions of one or more software programs stored in image processing device 200 (e.g., within memory 230). In some example implementations, the processor 220 is one or more ISPs that are part of a camera controller (not shown) for controlling the multiple camera module 210. Processor 220 may include one or more stages of an image processing pipeline. For example, processor 220 may execute the image capture SW module 241 to capture and receive images using the multiple camera module 210. Processor 220 may also execute the image sensor synchronization SW module 242 to generate and send synchronization signals for synchronizing the slave image sensor 212 to the master image sensor 211. Processor 220 may further execute the image processing SW module 243 to perform image processing operations on captured images. While the below examples and implementations are described regarding the image processing device 200 of FIG. 2, other example devices with multiple cameras may be used to perform the examples, and the present disclosure should not be limited to the example image processing device 200.

As described above, devices may include a master image sensor 211 and a slave image sensor 212. The slave image sensor 212 may be synchronized to the master image sensor 211. The time for the device 200 to complete the one or more image processing operations may exceed the time between frame captures for an image sensor. For example, the frame capture rate for the master image sensor 211 and the slave image sensor 212 may be 30 frames per second (fps), with the time between frame captures being 1/30 seconds or 33 milliseconds. However, the device 200 may take more than 33 milliseconds to execute one or more image processing operations for an image capture.

For example, one type of image capture and processing operation that may consume more time than exists between capturing frames is real-time bokeh operations. Bokeh refers to the blur in out-of-focus parts of an image captured by a lensed camera. Bokeh occurs in parts of a captured scene outside the depth of field of the camera lens. Many devices include image sensors that are not capable of naturally generating bokeh effects. However, real-time bokeh operations after image capture may be used to simulate bokeh effects in an image. Often, real-time bokeh operations include determining a depth map for a captured image, where each pixel of the depth map indicates a proximity of an object at a corresponding pixel of the captured image. For example, each pixel of the depth map may have a luminance corresponding to a distance of an object from an image sensor. Determining a depth map may require 66 milliseconds or longer, which exceeds 33 milliseconds between image captures if capturing at 30 fps. As a result, a depth map may not be determined for every image to be captured by the image sensors, and power may be wastefully consumed if the image sensors continue to run at their nominal rates. More particularly, the master image sensor continues to transmit synchronization signals while the depth map is determined, and the slave image sensor continues to respond to these synchronization signals by wastefully capturing image frames which are not used because the depth map is still being determined.

In addition, other types of image capture and processing operations may consume more time than exists between capturing frames. Example operations may include advanced optical zoom operations employing both a wide and a tele lens, three-dimensional rendering applications where a depth sensor may be required to work in synchronization with a main image sensor, features such as synchronized front camera and rear camera recording, 360-degree camera operations, and so on.

Accordingly, a device 200 may configure a slave image sensor 212 to conserve power during image processing operations. More particularly, the device 200 may be configured to selectively adjust a frame update rate of the slave image sensor 212 while retaining synchronization to the master image sensor 211.

In some example implementations, the device 200 may configure the slave image sensor 212 to selectively adjust the frame update rate by configuring the slave image sensor 212 to selectively ignore one or more synchronization signals while retaining synchronization to a master image sensor 211. When a slave image sensor “ignores” a synchronization signal, no image frame corresponding to the ignored synchronization signal may be captured by the slave image sensor. For example, an ignored synchronization signal may be received by the slave image sensor, but then discarded.

More particularly, a synchronization signal may be periodically sent from the master image sensor 211 to the slave image sensor. Such a synchronization signal may be sent once per synchronization period, and may indicate a frame start time for capturing an image frame by each of the master image sensor 211 and the slave image sensor 212. For example, the synchronization signal may indicate a clock edge of a clock signal for the multiple camera module 210—such as a next subsequent clock edge—corresponding to the frame start time. Thus, the synchronization period may be the period of time between a first clock edge corresponding to a start time for a first frame, and a second clock edge corresponding to a start time for a second frame immediately subsequent to the first frame. Instructions may be received to perform an image processing operation, such as determining a depth map in association with a real-time bokeh operation. A determination may be made whether or not the image processing operation will take longer to complete than the synchronization period. For example, the device 200 may estimate a required time for completing the image processing operation, and may compare the estimated time to the synchronization period. The device 200 may then instruct the slave image sensor 212 to selectively ignore one or more synchronization signals based at least in part on the comparison between the estimated time and the synchronization period. For each ignored synchronization signal, the slave image sensor 212 may conserve power by not capturing image data during the frames corresponding to the ignored one or more synchronization signals.

In some example implementations, the device 200 may instruct the slave image sensor 212, after the image processing operation has completed, to stop selectively ignoring synchronization signals.

In some aspects, the master image sensor 211 and the slave image sensor 212 may initially be configured to capture frames at a first frequency (such as 30 fps). After estimating that the time for completing the image processing operation exceeds the synchronization period (such as estimating a time greater than approximately 33 ms), the device 200 may configure the slave image sensor 212 to capture frames at a fraction of the first frequency (such as half the first frequency, which is 15 fps if the first frequency is 30 fps), and the master image sensor 211 may continue to capture frames at the first frequency. For example, if the slave image sensor 212 is to capture frames at half the first frequency, the device 200 may configure the slave image sensor 212 to ignore every other synchronization signal sent from the master image sensor.

In another aspect, selectively ignoring one or more synchronization signals may include receiving a first synchronization signal marking a frame start time for a first frame of the slave image sensor 212, ignoring a number of subsequently received synchronization signals, and receiving a second synchronization signal marking a frame start time for a second frame of the slave image sensor 212. In some aspects, the number of synchronization signals to be ignored between the first synchronization signal and the second synchronization signal may be based at least in part on a ratio between the estimated time for completing the image processing operation and the synchronization period. For example, if the device 200 estimates that an image processing operation is to take between one and two times the synchronization period (if the ratio is between one and two), the device 200 may configure the slave image sensor 212 to ignore every other synchronization signal during the image processing operation. Similarly, if the ratio is between two and three, the device 200 may configure the slave image sensor 212 to ignore two synchronization signals between the first synchronization signal and the second synchronization signal.

In some other example implementations, the device 200 may configure the slave image sensor 212 to selectively adjust the frame update rate by configuring the master image sensor 211 to selectively refrain from transmitting one or more synchronization signals to the slave image sensor 212. When a master image sensor “refrains” from transmission of a synchronization signal, the master image sensor captures an image frame but does not send a synchronization signal at a frame start time. Thus, the slave image sensor does not receive the unsent synchronization signal and does not capture a corresponding image frame. Consequently, the slave image sensor 212 retains synchronization to the master image sensor 211 but does not wastefully consume power during the image processing operation.

In some aspects, the master image sensor 211 and the slave image sensor 212 may initially be configured to capture frames at a first frequency (such as 30 fps). After estimating that the time for completing the image processing operation exceeds the synchronization period (such as estimating a time greater than approximately 33 ms), the device 200 may configure the master image sensor 212 to transmit synchronization signals to the slave image sensor 212 at a reduced frequency by refraining from transmitting one or more synchronization signals. For example, the master image sensor may be configured to transmit synchronization signals at half the first frequency, which is 15 fps if the first frequency is 30 fps, while the master image sensor 211 may continue to capture frames at the first frequency. For example, if the slave image sensor 212 is to capture frames at half the first frequency, the device 200 may configure the master image sensor 211 to refrain from transmitting every other synchronization signal sent to the slave image sensor.

In another aspect, selectively refraining from transmitting one or more synchronization signals may include transmitting a first synchronization signal marking a frame start time for a first frame of the slave image sensor 212, refraining from transmission of a number of synchronization signals, and transmitting a second synchronization signal marking a frame start time for a second frame of the slave image sensor 212. In some aspects, the master image sensor may refrain from transmission of number of synchronization signals which is based at least in part on a ratio between the estimated time for completing the image processing operation and the synchronization period. For example, if the device 200 estimates that an image processing operation is to take between one and two times the synchronization period (if the ratio is between one and two), the device 200 may configure the master image sensor 211 to refrain from transmission of every other synchronization signal during the image processing operation. Similarly, if the ratio is between two and three, the device 200 may configure the master image sensor 211 to refrain from transmission of two synchronization signals between the first synchronization signal and the second synchronization signal.

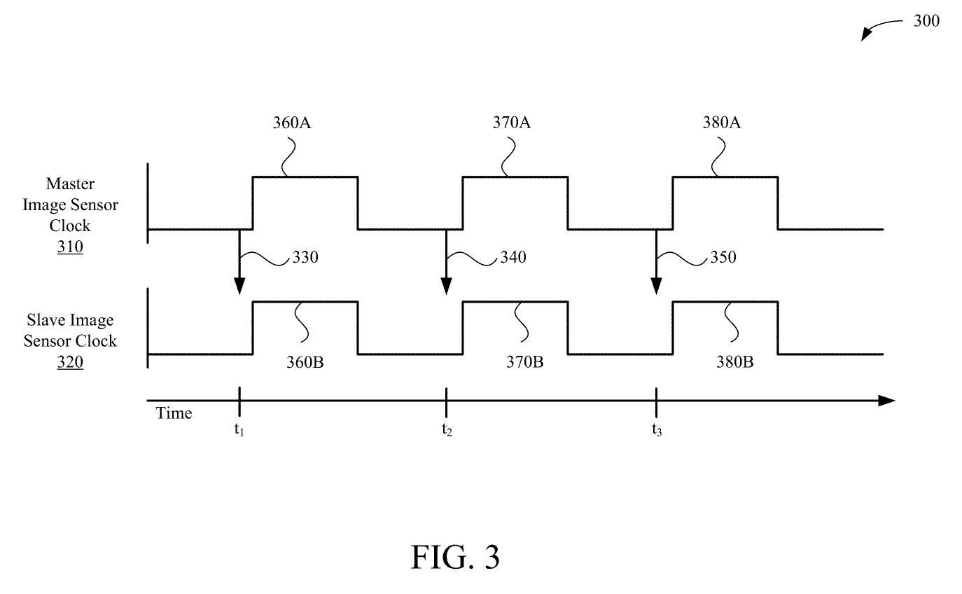

FIG. 3 is a plot 300 depicting a slave image sensor clock 320 synchronized to a master image sensor clock 310. With respect to FIG. 3, a master image sensor clock 310 of a master image sensor, such as master image sensor 211, operates at a first frequency. A synchronization signal may be sent to the slave image sensor 212 once per period of the master image clock 310 for synchronizing the slave image sensor clock 320 to the master image sensor clock 310. For example, a first synchronization signal 330 may be sent at a first time t₁, a second synchronization signal 340 may be sent at a second time t₂, and a third synchronization signal 350 may be sent at a third time t₃. Each synchronization signal may indicate a start of a corresponding frame, and may correspond to an edge (such as a rising edge) of the master image sensor clock 310. The slave image sensor 212 may receive each synchronization signal and align the capture of an image frame based on a corresponding synchronization signal, thus synchronizing the frame capture of the slave image sensor 212 to a corresponding frame capture of the master image sensor 211. For example, the first synchronization signal 330 may indicate the start of the master image frame capture 360A, and the slave image sensor 212 may be configured based on the first synchronization signal 330 to align the start of the slave image frame capture 360B to the start of the master image frame capture 360A. Similarly, the second synchronization signal 340 may indicate the start of master image frame capture 370A, and the slave image sensor 212 may be configured based on the second synchronization signal 340 to align the start of slave image frame capture 370B to the start of the master image frame capture 370A. Further, the third synchronization signal 350 may indicate the start of the master image frame capture 380A, and the slave image sensor 212 may be configured based on the third synchronization signal 350 to align the start of the slave image frame capture 380B to the start of the master image frame capture 380A.

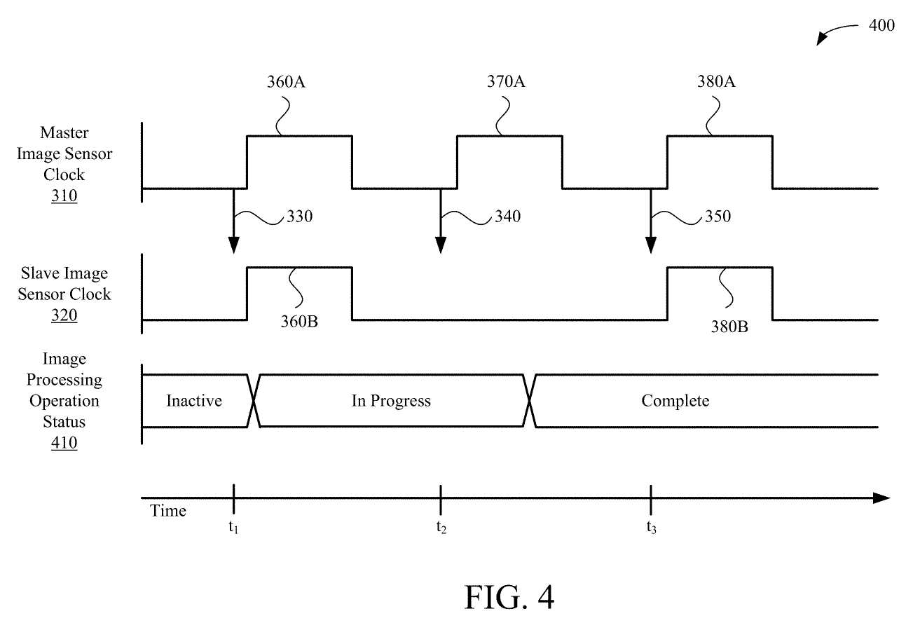

FIG. 4 is an example plot 400 depicting a slave image sensor clock 320 synchronized to a master image sensor clock 310 for an implementation where the slave image sensor 212 is configured to ignore a synchronization signal 340. Similar to FIG. 3, the slave image sensor clock 320 is synchronized to the master image sensor clock 310, and the master image sensor 211 sends the synchronization signals 330, 340, and 350, corresponding respectively to master image frame captures 360A, 370A, and 380A. As depicted in FIG. 4, the slave image sensor 212 selectively ignores one or more synchronization signals based on an in-progress image processing operation. The image processing operation status 410 depicts if an image processing operation is in progress. When the image processing operation status 410 is “Active” then the device 200 is performing an image processing operation. For example, a camera controller or image signal processor (ISP) may be performing the image processing operation. A determination may be made that the estimated time to complete the image processing operation is greater than the synchronization period. For example, a processor, or a camera controller may make such a determination. In some implementations, the determination may be based on a list of image processing operations requiring more time to complete than the synchronization period. For example, a lookup table (LUT) may be maintained including the list. In response, the slave image sensor 212 may be configured to selectively ignore one or more synchronization signals. For example, the camera controller or the ISP may configure the slave image sensor 212 to selectively ignore the one or more synchronization signals. As shown in FIG. 4, the image processing operation status 410 indicates that the device 200 is not performing an image processing operation (“Inactive”) at the start of the master image frame capture 360A. As a result, the slave image sensor 212 may be configured based on the first synchronization signal 330 to align the start of the slave image frame capture 360B to the start of the master image frame capture 360A. However, the image processing operation status 410 indicates that the device 200 is performing an image processing operation (“In Progress”) at the start of the master image frame capture 370A. For example, the device 200 may estimate before or during the image processing operation the time required for completing the operation, and configure the slave image sensor 212 to ignore synchronization signals during the estimated time. As a result, the slave image sensor 212 may ignore the second synchronization signal 340, thus conserving power by not capturing a slave image frame corresponding to an image frame from the master image frame capture 370A. The image signal processing status 410 indicates that the device 200 has completed performing an image processing operation (“Complete”) at the start of the master image frame capture 380A. For example, the estimated time for completing the image processing operation may have ended. As a result, the slave image sensor 212 may be configured based on the third synchronization signal 350 to align the start of the slave image frame capture 380B to the start of the master image frame capture 380A.

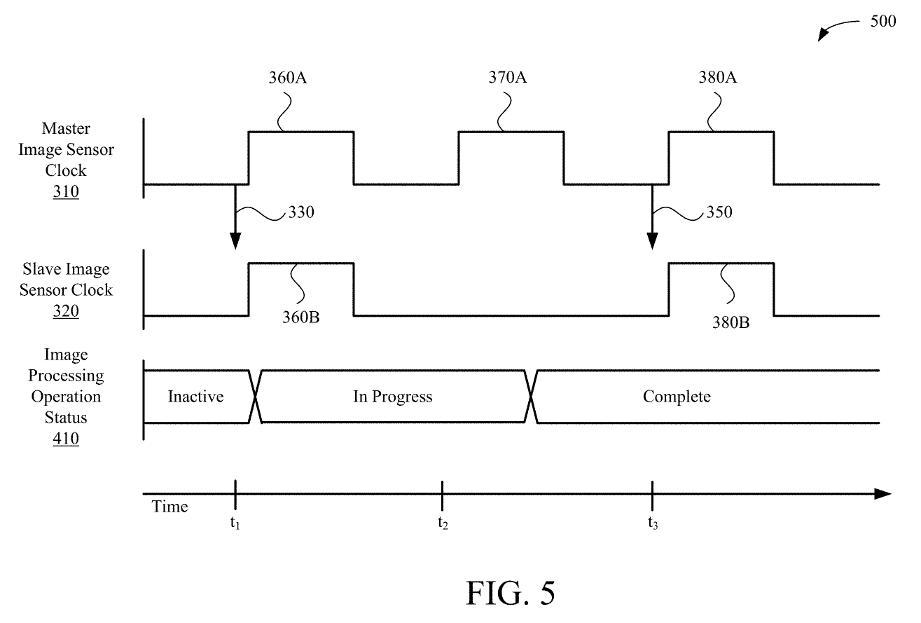

FIG. 5 is another example plot 500 depicting a slave image sensor clock 320 synchronized to a master image sensor clock 310, for an implementation where the master image sensor 211 is configured to refrain from transmitting a synchronization signal 340. Similar to FIG. 3, the slave image sensor clock 320 is synchronized to the master image sensor clock 310, and the master image sensor 211 sends the synchronization signals 330, and 350, corresponding respectively to master image frame captures 360A and 380A. As depicted in FIG. 5, the master image sensor 211 selectively refrains from transmitting one or more synchronization signals based on an in-progress image processing operation. The image processing operation status 410 depicts if an image processing operation is in progress. When the image processing operation status 410 is “Active” then the device 200 is performing an image processing operation. For example, a camera controller or image signal processor (ISP) may be performing the image processing operation. A determination may be made that the estimated time to complete the image processing operation is greater than the synchronization period. For example, a processor, or a camera controller may make such a determination. In some implementations, the determination may be based on a list of image processing operations requiring more time to complete than the synchronization period. For example, a lookup table (LUT) may be maintained including the list. In response, the master image sensor 211 may be configured to selectively refrain from transmission of one or more synchronization signals. For example, the camera controller or the ISP may configure the master image sensor 211 to selectively refrain from transmitting the one or more synchronization signals. As shown in FIG. 5, the image processing operation status 410 indicates that the device 200 is not performing an image processing operation (“Inactive”) at the start of the master image frame capture 360A. As a result, the slave image sensor 212 may be configured based on the first synchronization signal 330 to align the start of the slave image frame capture 360B to the start of the master image frame capture 360A. However, the image processing operation status 410 indicates that the device 200 is performing an image processing operation (“In Progress”) at the start of the master image frame capture 370A. For example, the device 200 may estimate before or during the image processing operation the time required for completing the operation, and configure the master image sensor 211 to refrain from transmission of synchronization signals during the estimated time. As a result, the master image sensor 211 may refrain from transmission of the synchronization signal 340, thus conserving power by not directing the slave image sensor to capture a slave image frame corresponding to an image frame from the master image frame capture 370A. The image signal processing status 410 indicates that the device 200 has completed performing an image processing operation (“Complete”) at the start of the master image frame capture 380A. For example, the estimated time for completing the image processing operation may have ended. As a result, the master image sensor may transmit synchronization signal 350 and the slave image sensor 212 may respond to synchronization signal 350 by aligning the start of the slave image frame capture 380B to the start of the master image frame capture 380A.

FIG. 6 is an illustrative flow chart depicting an example operation 600 for selectively ignoring by a slave image sensor 212 one or more synchronization signals from a master image sensor 211. With respect to FIG. 6, a synchronization signal may be periodically sent from the master image sensor 211 to the slave image sensor 212, where the synchronization signal is sent once per synchronization period, and indicates a frame start time (610). For some implementations, the synchronization signal may be periodically sent by executing image sensor synchronization SW module 242 of image processing device 200 of FIG. 2. A time may be estimated required to complete an image processing operation (620). For some implementations, the time may be estimated by executing image processing SW module 243 of image processing device 200 of FIG. 2. The estimated time may be compared to the synchronization period (630). For some implementations, this comparison may be made by executing image sensor synchronization SW module 242 of image processing device 200 of FIG. 2. The frame update rate of the slave image sensor 212 may then be selectively adjusted based at least in part on the comparison (640). For some implementations, the frame update rate of the slave image sensor may be selectively adjusted by executing image sensor synchronization SW module 242 of image processing device 200 of FIG. 2.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as memory 230 in FIG. 2) comprising instructions (such as image capture SW module 241, image sensor synchronization SW module 242, or image processing SW module 243) that, when executed by one or more processors (such as processor 220), performs one or more of the methods or portions of the methods (such as example operation 600 in FIG. 6) described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the implementations disclosed herein may be executed by one or more processors (such as processor 220 in FIG. 2). Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. Additionally, the functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated.

Accordingly, the disclosure is not limited to the illustrated examples, and any means for performing the functionality described herein are included in aspects of the disclosure.

What is claimed is:

1. A method for image capture, comprising:
periodically sending a synchronization signal from a master image sensor of a multiple camera module to a slave image sensor of the multiple camera module, the synchronization signal sent once per synchronization period and indicating a frame start time;
estimating a time required to complete an image processing operation;
comparing the estimated time to the synchronization period; and
selectively adjusting a frame update rate of the slave image sensor based at least in part on the comparing.

2. The method of claim 1, wherein the image processing operation is a determination of a depth map indicating proximities of objects in a scene captured by the master and the slave image sensors.

3. The method of claim 1, further comprising determining that the image processing operation has completed, and instructing the slave image sensor to cease selectively ignoring synchronization signals.

4. The method of claim 1, wherein selectively adjusting the frame update rate of the slave image sensor comprises, at the slave image sensor:
receiving a first synchronization signal indicating a frame start time for a first frame to be captured by the slave image sensor;
ignoring a number of subsequently received synchronization signals; and
receiving a second synchronization signal indicating a frame start time for a second frame to be captured by the slave image sensor.

5. The method of claim 4, wherein the number of ignored synchronization signals is based at least in part on a ratio between the estimated time and the synchronization period.

6. The method of claim 4, wherein selectively ignoring one or more synchronization signals comprises ignoring every other synchronization signal received from the master image sensor.

7. The method of claim 1, wherein the synchronization signal indicates a clock edge corresponding to the frame start time.

8. The method of claim 1, wherein selectively adjusting the frame update rate of the slave image sensor comprises, at the master image sensor:
transmitting a first synchronization signal indicating a frame start time for a first frame to be captured by the slave image sensor;
refraining from transmission of a number of subsequent synchronization signals; and
transmitting a second synchronization signal indicating a frame start time for a second frame to be captured by the slave image sensor.

9. The method of claim 8, wherein the master image sensor refrains from transmission of a number of synchronization signals which is based at least in part on a ratio between the estimated time and the synchronization period.

10. The method of claim 8, wherein the master image sensor refrains from transmission of every other synchronization signal.

11. An image processing device, comprising:
two or more image sensors, comprising a master image sensor and a slave image sensor synchronized to the master image sensor;
one or more processors; and
a memory, coupled to the two or more image sensors and to the one or more processors, storing instructions that, when executed by the one or more processors, cause the image processing device to:
periodically send a synchronization signal from the master image sensor to the slave image sensor, the synchronization signal sent once per synchronization period and indicating a frame start time;
estimate a time required to complete an image processing operation;
compare the estimated time to the synchronization period; and
selectively adjust a frame update rate of the slave image sensor based at least in part on the comparing.

12. The image processing device of claim 11, wherein the image processing operation is a determination of a depth map indicating proximities of objects in a scene captured by the master and the slave image sensors.

13. The image processing device of claim 11, wherein execution of the instructions further causes the image processing device to determine that the image processing operation has completed, and instruct the slave image sensor to cease selectively ignoring synchronization signals.

14. The image processing device of claim 11, wherein execution of the instructions to selectively adjust the frame update rate of the slave image sensor further causes the image processing device to, at the slave image sensor:
receive a first synchronization signal indicating a frame start time for a first frame to be captured by the slave image sensor;
ignore a number of subsequently received synchronization signals; and
receive a second synchronization signal indicating a frame start time for a second frame to be captured by the slave image sensor.

15. The image processing device of claim 14, wherein the number of ignored synchronization signals is based at least in part on a ratio between the estimated time and the synchronization period.

16. The image processing device of claim 14, wherein selectively ignoring one or more synchronization signals comprises ignoring every other synchronization signal received from the master image sensor.

17. The image processing device of claim 11, wherein the synchronization signal indicates a clock edge corresponding to the frame start time.

18. The image processing device of claim 11, wherein execution of the instructions to selectively adjust the frame update rate of the slave image sensor further causes the image processing device to, at the master image sensor:
transmit a first synchronization signal indicating a frame start time for a first frame to be captured by the slave image sensor;
refraining from transmission of a number of subsequent synchronization signals; and
transmitting a second synchronization signal indicating a frame start time for a second frame to be captured by the slave image sensor.

19. The image processing device of claim 18, wherein the master image sensor refrains from transmission of a number of synchronization signals which is based at least in part on a ratio between the estimated time and the synchronization period.

20. The image processing device of claim 18, wherein the master image sensor refrains from transmission of every other synchronization signal.

21. A non-transitory computer-readable storage medium storing instructions that, when executed by one or more processors of an image processing device, cause the image processing device to:
periodically send a synchronization signal from a master image sensor to a slave image sensor synchronized to the master image sensor, the synchronization signal sent once per synchronization period and indicating a frame start time;
estimate a time required to complete an image processing operation;
compare the estimated time to the synchronization period; and
selectively adjust a frame update rate of the slave image sensor based at least in part on the comparing.

22. The non-transitory computer-readable storage medium of claim 21, wherein the image processing operation is a determination of a depth map indicating proximities of objects in a scene captured by the master and the slave image sensors.

23. The non-transitory computer-readable storage medium of claim 21, wherein execution of the instructions further causes the image processing device to determine that the image processing operation has completed, and instruct the slave image sensor to cease selectively ignoring synchronization signals.

24. The non-transitory computer-readable storage medium of claim 21, wherein execution of the instructions to selectively adjust the frame update rate of the slave image sensor further causes the image processing device to, at the slave image sensor:
receive a first synchronization signal indicating a frame start time for a first frame to be captured by the slave image sensor;
ignore a number of subsequently received synchronization signals; and
receive a second synchronization signal indicating a frame start time for a second frame to be captured by the slave image sensor.

25. The non-transitory computer-readable storage medium of claim 24, wherein the number of ignored synchronization signals is based at least in part on a ratio between the estimated time and the synchronization period.

26. The non-transitory computer-readable storage medium of claim 24, wherein selectively ignoring one or more synchronization signals comprises ignoring every other synchronization signal received from the master image sensor.

27. The non-transitory computer-readable storage medium of claim 21, wherein the synchronization signal indicates a clock edge corresponding to the frame start time.

28. The non-transitory computer-readable storage medium of claim 21, wherein execution of the instructions to selectively adjust the frame update rate of the slave image sensor further causes the image processing device to, at the master image sensor:
transmit a first synchronization signal indicating a frame start time for a first frame to be captured by the slave image sensor;
refraining from transmission of a number of subsequent synchronization signals; and
transmitting a second synchronization signal indicating a frame start time for a second frame to be captured by the slave image sensor.

29. The non-transitory computer-readable storage medium of claim 28, wherein the master image sensor refrains from transmission of a number of synchronization signals which is based at least in part on a ratio between the estimated time and the synchronization period.

30. An image processing device, comprising
means for periodically sending a synchronization signal from a master image sensor to a slave image sensor synchronized to the master image sensor, the synchronization signal sent once per synchronization period and indicating a frame start time;
means for estimating a time required to complete an image processing operation;
means for comparing the estimated time to the synchronization period; and
means for selectively adjusting a frame update rate of the slave image sensor based at least in part on the comparing.
